(19) United States
(12) Patent Application Publication
(10) Pub. No.: US 2024/0029535 A1
(43) Pub. Date: Jan. 25, 2024

(54) System and Method for Automated Detection of Hazards and Deployment of Warning Signs

(71) Applicant: Haroon Iqbal Badat, Houston, TX (US)

(72) Inventor: Haroon Iqbal Badat, Houston, TX (US)

(21) Appl. No.: 18/199,957

(22) Filed: May 21, 2023

Related U.S. Application Data
(60) Provisional application No. 63/368,796, filed on Jul. 19, 2022.

(51) Int. Cl. G08B 21/02; G06V 20/52; G06V 10/764; G06T 7/70; G06V 10/774; G06V 10/776

(52) U.S. Cl. CPC G08B 21/02; G06V 20/52; G06V 10/764; G06T 7/70; G06V 10/774; G06V 10/776; G06T 2207/30232; G06V 10/82

(57) ABSTRACT

A system to monitor for and respond to spills, objects, obstructions, or other hazards present on a premises. The system can include a visual monitoring component, the output of which can be sent to a processing unit for algorithmic detection, classification, and location identification of said hazards. The processing unit can transmit relevant data to a response unit that can automatically display warning signs at the location of the hazard and alert relevant parties. Alternatively, the output of the processing unit can be monitored by personnel, and the hazard type can be manually classified, and hazard location can be manually identified. Personnel can also manually deploy the warning sign. In both the automated and manual approaches, the system can be interacted with and controlled by means of a computing device.

### CROSS-REFERENCE TO RELATED APPLICATIONS

This application claims priority under 35 U.S.C. § 119(e) from co-pending U.S. Provisional Patent Application No. 63/368,796, by Haroon Iqbal Badat, “System and Method for Automated Detection of Hazards and Deployment of Warning Signs” filed 19 Jul. 2022, which, by this statement, is incorporated herein by reference for all purposes.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable.

### BACKGROUND OF THE INNOVATION

### Field of the Innovation

The present invention relates generally to surveillance and response systems and specifically to surveillance systems enhanced by artificial intelligence to automatically detect hazards and alert of their presence.

### Background of the Innovation

Every year, slip and fall cases account for over one million emergency room visits. Currently, the safety of patrons from such hazards on business premises unreliably depends on employee vigilance to detect, mark, and remedy such hazards. However, this strategy has proven to leave patrons vulnerable and becomes increasingly ineffective as premises size increases. With large retailers routinely having indoor premises of 180,000 square feet or more, employees aren't always able to detect such hazards before a patron or visitor sustains an injury.

The current method to protect patrons from the aforementioned hazards on premises, particularly spills and obstructions or objects that create a trip hazard, begins with visual detection of the hazard. Once the hazard is detected, the responsible party is alerted and the appropriate response is mobilized to deploy warning signs and remedy the hazard. Further, past inventions seeking to address this issue have failed to provide a practical and economical solution.

In U.S. patent Ser. No. 10/684,623B2, Tiwari et al. discloses a method for detecting and responding to spills and hazards using robotics. According to the specification, a robot patrols a premise while scanning the floor to create a composite image consisting of thermal, depth, and color information to detect spills or hazards. The use of robots to solve this problem reduces the practicality of implementing such a solution on a wide scale by introducing high costs for deployment and maintenance. In addition, placing a robot in a crowded premise, such as a retail store, presents a new hazard for patrons to remain wary of.

Another solution for detecting spills is disclosed by Fisher et al. in U.S. patent Ser. No. 10/967,519B2. The described invention also relies on robots to automate detection and remediation of spills and suffers from the same disadvantages as mentioned regarding the previous invention. Further, both of the aforementioned inventions cannot be easily integrated by leveraging the existing surveillance infrastructure of a premise or by the use of readily accessible components.

The limited number of proposed solutions to address this issue in a practical manner exposes the need for innovation in this space to create a solution that can integrate easily into existing surveillance infrastructure of most businesses and be installed for a relatively low-cost while providing a compelling return on investment—the safety of patrons. The invention disclosed herein provides such a solution.

### SUMMARY

An artificial intelligence-augmented surveillance and response system that is configured to detect spills and other hazards such as obstructions or objects around a premises using computer vision and automatically identify and illuminate the hazard while simultaneously notifying cleaning personnel to promptly remediate the hazard and parties in close proximity to exercise caution.

The system is designed to be easily incorporated into existing surveillance infrastructure. In one variant, live-video feed is transmitted from the surveillance infrastructure as input into one of a variety of possible computational platforms for operating machine learning models for inference generation. In this variant, hazard detection is achieved by a machine learning model that is trained on datasets consisting of labeled or annotated images of spills, objects or obstructions that may cause one to trip, falling object hazards, and other hazards that may cause patrons to sustain injury. The machine learning based detection mechanism determines whether a hazard is present, classifies the type of hazard, and identifies the location of the hazard within the premises. These hazard parameters are transmitted to a response system which, in at least one variant, consists of a sign projector to illuminate the hazard on the premises floor by displaying a warning sign in close proximity to the detected hazard. Additionally, the response system generates auditory and visual alerts directly to mobile devices as well as auditory alerts over intercom. For retail premises that offer mobile applications, push notifications can be delivered through the mobile application. Custodians of the surveilled premises can interact with the system through a mobile device to govern operation of the system.

The method and system for hazard detection and remediation disclosed herein offer several advantages compared to currently available solutions including, but not limited to, the ability to easily integrate with existing surveillance infrastructure at a relatively low-cost using readily accessible components, immediately detect, classify, and map the location of certain hazards in real-time, support employees in their responsibility of patrolling the premises to search for hazards, and significantly reduce frequency of injury to patrons or visitors from those hazards.

### BRIEF DESCRIPTION OF THE DRAWINGS

FIG. 1 is a flow diagram of a system for monitoring live surveillance footage for hazards, deploying a custom warning sign based on the type of hazard present (e.g. spill, obstruction, trip hazard, falling object hazard, etc.), generating an auditory alert around the premises, and directly alerting responsible parties in accordance with an exemplary implementation of the present innovation.

FIG. 2 is a front perspective view of the sign projection system in accordance with an exemplary implementation of the present innovation.

FIG. 3 is a rear perspective view of the sign projection system in accordance with an exemplary implementation of the present innovation.

FIG. 4 is an aerial view of a premises with projected visual alerts in accordance with an exemplary implementation of the present innovation.

FIG. 5 is a sectional view of a premises with an augmented surveillance and response system constructed in accordance with an exemplary implementation of the present innovation.

FIG. 6 is a view of surveillance footage with x-coordinate and y-coordinate of a spill mapped in accordance with an exemplary implementation of the present invention.

FIG. 7 is a view of surveillance footage showing a drone projecting a warning sign at the location of the hazard.

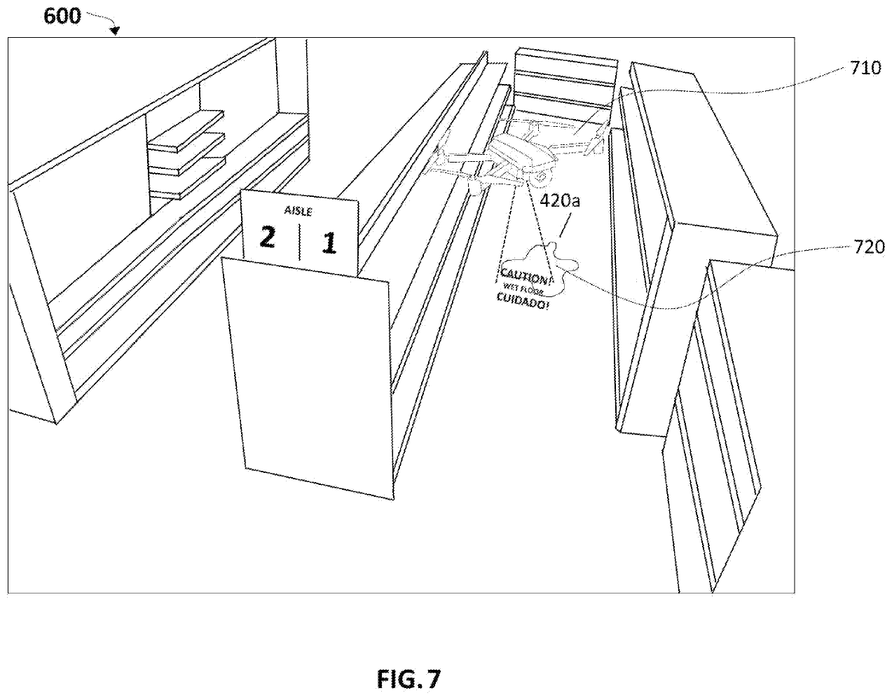

FIG. 8 is a view of surveillance footage showing a retractable sign deploying in close proximity to the detected hazard.

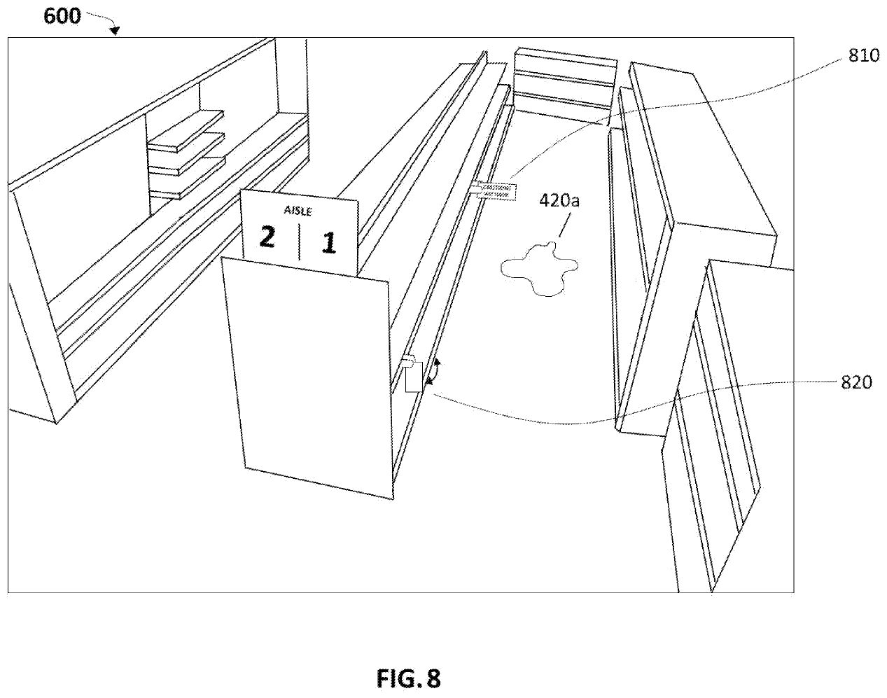

### DETAILED DESCRIPTION OF THE INVENTION

The innovation consists of a system that receives an input of live surveillance footage from surveillance cameras installed around a surveilled premises, processes the footage through a machine learning algorithm trained to detect spills, objects or obstructions, falling object hazards or other hazards that may make one susceptible to falling or sustaining injuries, and triggers a response system to illuminate the detected hazard while alerting custodians and patrons of the surveilled premises. Communication between the various components of the system can be facilitated by a server with each component of the system—surveillance infrastructure, detection system, and response system—coupled with the server.

In one embodiment, the detection mechanism can employ a machine learning algorithm such as a convolutional neural network trained on datasets consisting of labeled or annotated images of spills, objects or obstructions that may cause one to trip, falling object hazards, and other hazards that may cause patrons to sustain injury. Synthetic data can also be used to increase the size and diversity of the training data, thereby improving the model's ability to detect hazards. The training can be conducted using a supervised learning technique featuring backpropagation. The model performance can be further optimized by adjusting hyperparameters. The validation and subsequent selection of the ideal model can be achieved using a validation dataset or real-world testing with live surveillance video. Model accuracy can be further improved by enabling human feedback during real-world operations. False positives or missed detections during operation can be reported to the system to broaden detection capability of the detection mechanism.

The machine-learning model can be deployed on one or more computational platforms consisting, at least in part, of processors and multiple computer-readable media including, but not limited to, cloud compute services, serverless compute platforms, edge devices, or on-premises servers. The computational platform can provide a plurality of nodes to operate multiple instances of the detection model to enable the system to detect multiple hazards simultaneously. As such, the system is able to simultaneously process new footage from existing surveillance infrastructure through the machine learning algorithm to detect, classify, and map the location of hazards in real-time. The surveillance footage of each surveillance camera can be conditioned to enhance the visibility of relevant features to improve detection capability (i.e. infrared or thermal features). Other examples of image conditioning to enhance detection capability may include image sharpening, adjusting brightness or contrast, or background subtraction, among others.

In surveilled settings, surveillance cameras are generally labeled according to which region of the premises they monitor, providing a general reference to the location within the premises being surveilled by the camera. The location labels of cameras can be used in combination with a reference grid to enable accurate mapping of hazards once they are detected. In one embodiment, location mapping is achieved by virtually superimposing a reference grid utilizing a coordinate system with longitudinal and lateral labels on the premises' floor area. The reference grid would enable consistent and granular referencing to a physical location on the premises. In another embodiment, a Cartesian coordinate system can be superimposed on the viewing window of the surveillance footage to identify the precise virtual location of the hazard and direct the projection system to point to the physical location of the hazard.

Once the algorithm detects any hazards, the system determines the longitudinal and lateral coordinates of the hazard's location on the premises floor and activates the projection system in closest proximity to the spill. A plurality of projection systems can be mounted around the premises to ensure complete coverage. The projection systems can be mounted to the ceiling, on top of shelving, or any elevated platform that will enable each projector to cover a broad range of the premises floor area to reduce the number of projection systems required to ensure complete coverage of the premises. Each projection system's articulation in both the vertical and horizontal planes is achieved through a combination of servo motors. Each projection system is, at the time of installation, calibrated to the reference grid to enable consistent referencing of coordinates superimposed on the premises floor. The calibration procedure can also be repeated to accommodate changes to the floor layout. Simultaneously, in addition to deploying the visual alert via projection system, an automated auditory alert can be generated over speakers or an intercom system announcing the presence and location of the hazard on the premises. The auditory and visual alert can also be transmitted over mobile devices. In another variant, the system can integrate with existing mobile applications for retail premises, and the alert can be administered via push notifications through the respective mobile application. In one embodiment, data transmission between the response system and mobile application can be achieved through HTTP protocol.

In an alternate hazard mapping approach, the system can determine the location of the hazard in the viewing window of the surveillance footage by referencing the aforementioned Cartesian coordinates of the hazard, thereby identifying the virtual location of the hazard, and transmit the location coordinates to the projection system. The angles for the horizontal panning functionality and vertical tilt functionality to target the correct area near the longitudinal and lateral coordinates of the premises or the Cartesian coordinates of the camera footage can be calibrated during installation of the system through trigonometric calculations or by iteratively panning and tilting the projection system across the camera's field of view to calibrate the projector's range to remain restricted within the camera's field of view. In an alternate embodiment of the present invention, a drone can be utilized to navigate to the location of the spill and either hover over the hazard to project a virtual sign or deliver a physical sign at the location of the spill. In yet another embodiment, pop-up signs can be installed at set intervals on each aisle and be deployed when a hazard is detected nearby. These signs can be installed at 3 ft intervals on the shelving units along the aisles and be activated when a hazard is reported within 1.5 ft of the sign. By default, the sign will remain retracted until a hazard is detected and reported to be in its vicinity. To prevent collision with patrons, the signs can be equipped with proximity sensors to prevent deployment when a human or object is detected within the sign's field of operation.

In addition to deploying the system for visual alerts, the system can alert the responsible parties on the nature and location of the hazard through a computing device. Upon removal of the hazard, the warning sign can be retracted through either manual command through an interface available on a computing device or automated detection of hazard removal by the system. In the automated detection approach, the system, which continually monitors for removal of the hazard, removes the warning sign once the hazard is no longer present. In the manual approach, the relevant party can provide feedback to the system that the hazard has been removed through a graphical user interface, command line interface, or text message.

### DETAILED DESCRIPTION OF THE DRAWINGS

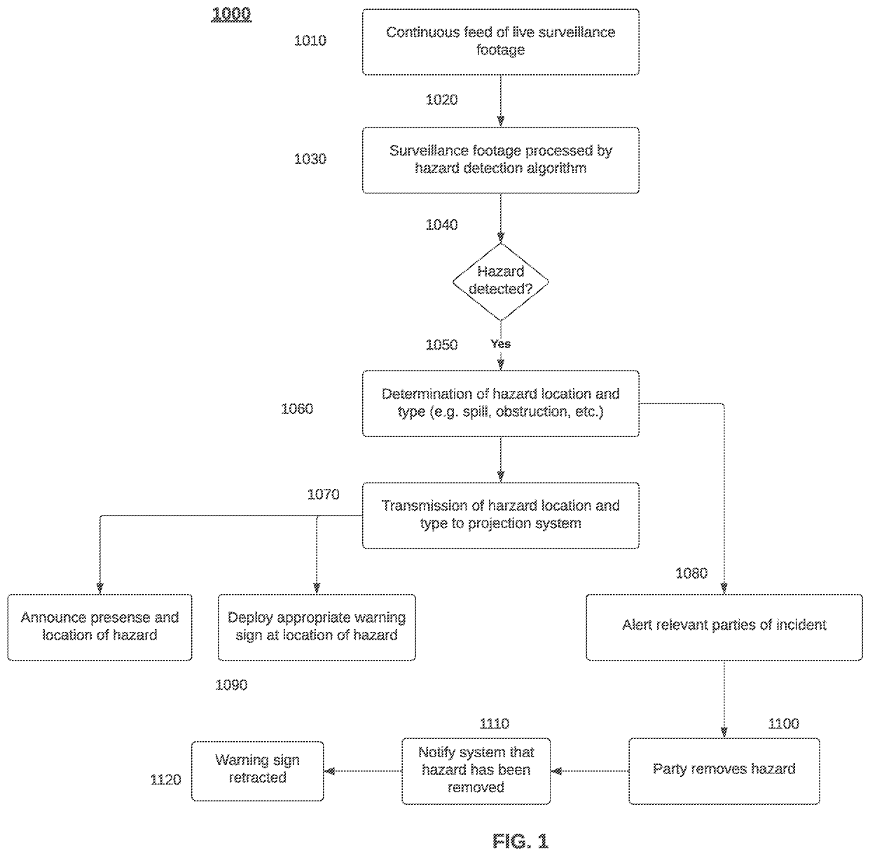

FIG. 1 depicts a flow diagram 1000 of a method for monitoring live surveillance footage for the detection, announcement, and removal of hazards in accordance with an exemplary implementation of the present invention. The diagram represents the perpetually looping operation of the system as it simultaneously processes footage from each surveillance camera. A live surveillance feed of the premises is continuously recorded 1010 and passed 1020 to the hazard detection algorithm for real-time processing 1030 and hazard detection 1040. Step 1010 continues perpetually in order to detect multiple instances of hazards and across several instances of the detection algorithm operation on the computational infrastructure. Once a hazard is detected 1050, the hazard detection algorithm makes a determination as to the location and type of hazard 1060. Upon determination of the physical and virtual location and type information, the system transmits 1070 virtual location, physical location, and hazard type to the projection system and alerts 1080 relevant parties of the incident. Using the location and hazard type information, the response system then deploys 1090 the appropriate warning sign at the location of the hazard and generates an auditory alert by announcing the presence and location of the hazard. After removing 1100 the hazard, the relevant party can notify 1110 the system through an interface on a computing device that the hazard has been removed. By way of example, in one variant, the relevant party can receive a notification of the hazard via text and confirm remediation of the hazard through a text response. Once the system receives input that the hazard has been remediated, the warning sign is retracted 1120.

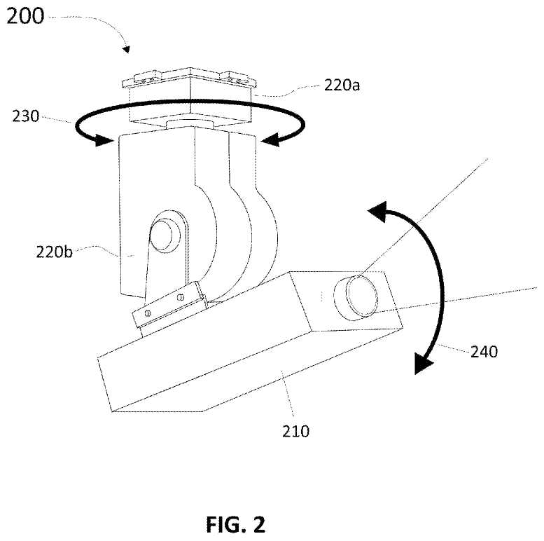

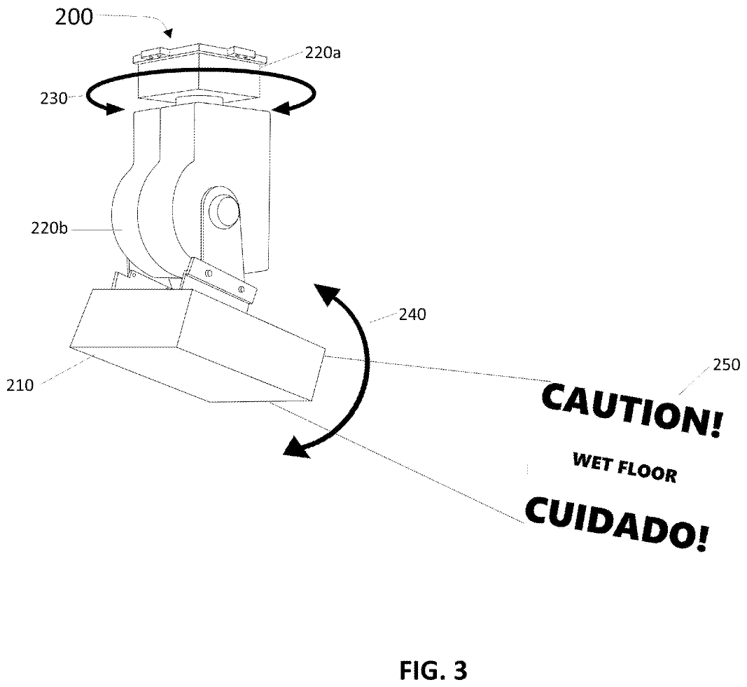

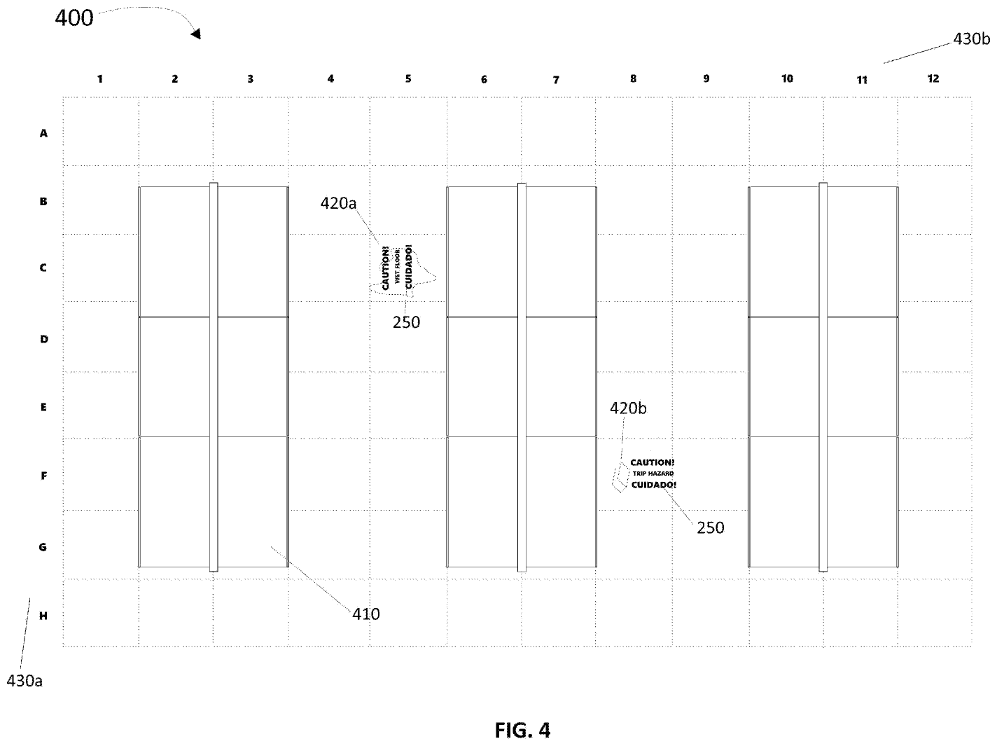

FIGS. 2 and 3 are front and rear perspective views, respectively, of a sign projection system 200 constructed in accordance with an exemplary implementation of the innovation. The sign projector 210 is mounted on a system of servo motors 220a and 220b for positioning the projection system 200. The servo motors 220a and 220b, provide sufficient range of motion to enable projection across a wide area. The projection system 200 can receive information through a wireless transmission protocol (i.e. Bluetooth or WiFi) or through a wired connection. Upon receiving location information in the form of coordinates based on a superimposed grid 400 (shown in FIG. 4) from the surveillance system, the projection system is able to adjust its angle in both the horizontal and vertical planes (as illustrated by the arrows 230 and 240, respectively) to accurately project alerts at the area of interest. Alerts can consist of color changing or flashing projections in order to be easily detected by patrons' peripheral field of vision which utilizes the rod-cells of the human eye; these rod-cells are attuned to detecting movement in the peripheral vision.

FIG. 4 is an aerial surveillance view of a premises utilizing the present invention. A grid 400 is superimposed on the entire area of the premises to enable determination and communication of precise physical location information. In this aerial view, the top of the shelving units 410 are displayed to better illustrate how the grid is superimposed on the premises floor. The location and nature of the spill 420a or the trip hazard 420b can be captured and transmitted to the projection system 200 to project the appropriate warning sign 250 at the correct location. The appropriate warning sign is determined by the type of hazard present. Each component of the system can be equipped with wireless transmission capabilities to enable communication with other components of the system.

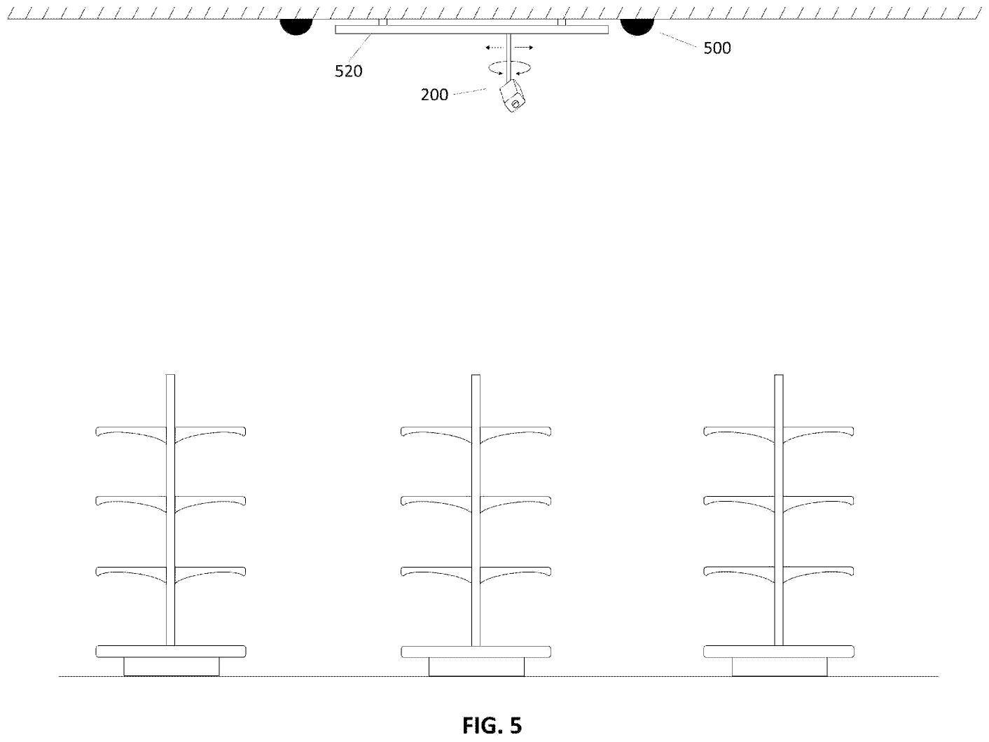

FIG. 5 is a sectional view of a premises with an augmented surveillance 500 and projection system 200 constructed in accordance with an exemplary implementation of the present innovation. The surveillance cameras 500 and the projection system 200 are attached to the ceiling of the building premises. The projection system can be mounted on a ceiling-mounted track 520 to enable lateral movement, thereby increasing the range of motion.

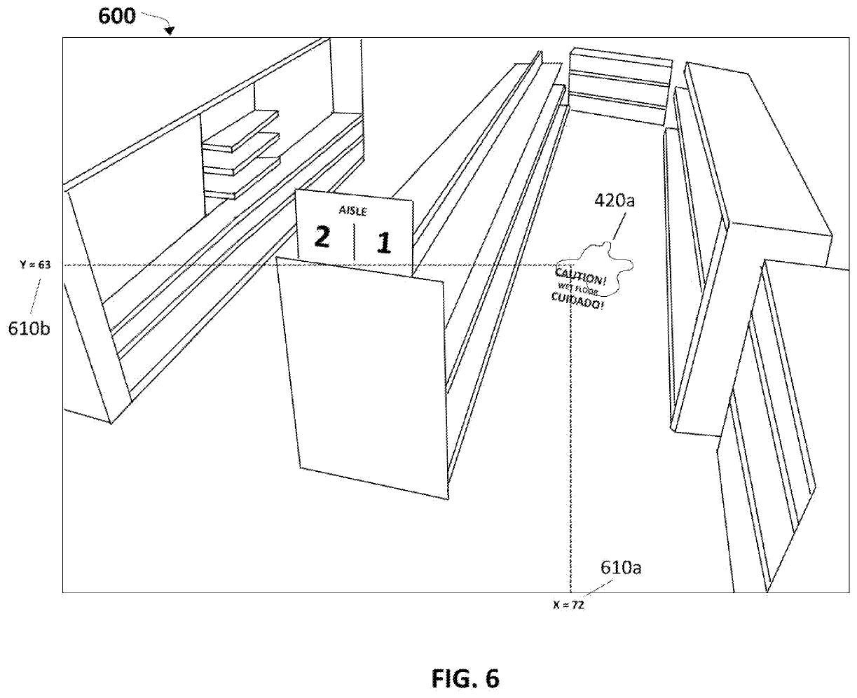

FIG. 6 is a sketch of a still image from surveillance footage 600. The footage 600 has Cartesian coordinates, 610a and 610b, superimposed on the footage 600 to provide a standardized approach to pinpointing a virtual location. This is in contrast to the coordinates from the grid illustrated in FIG. 4 which is used to map a physical location. The coordinates from the surveillance footage 600 are transmitted to the projection system 200 to guide the projection system 200 on where to aim the projected warning sign 250. The projection system 200 can be calibrated to the Cartesian coordinates 610a/610b of the virtual location during the installation process by panning the projector to the extreme ends of the surveillance camera's 500 field of view and marking those positions as the boundaries of the projector's 210 range of motion. By way of example, for a coordinate system with one hundred (100) equidistant points along the x and y axes, aiming the projector 210 at the bottom left corner of the footage 600 would correspond to the coordinates (0,0) while aiming the projector 210 at the top right corner of the footage 600 would correspond to the coordinates (100,100). Following the same convention, the projector 210 aimed at the top left corner would correspond to the point (0,100) and, when aimed at the bottom right corner, would correspond to the point (100,0). With the boundaries marked, the projector's 210 range of motion will be restricted to within the boundaries and be divided into a plurality of equivalent movements in the vertical and horizontal directions. This process will enable the projector 210 to aim the visual alert at the precise virtual location as identified on the footage 600 and each will reference the same Cartesian coordinates 610a/610b.

### REFERENCE NUMERALS

| | | | |
|---|---|---|---|
| 1000 | Flow diagram | 240 | Vertical tilt |
| | | | functionality |
| 1010 | Surveillance feed continuously | 250 | Warning sign |
| | recorded | | |
| 1020 | Feed passed to hazard detection | 400 | Superimposed grid |
| | algorithm | | |
| 1030 | Real-time processing of footage | 410 | Shelving unit |
| 1040 | Hazard detection process | 420a | Spill |
| 1050 | Hazard detected | 420b | Trip hazard/ |
| | | | obstruction |
| 1060 | Hazard type classification and | 430a | Longitudinal |
| | location identification | | coordinates |
| 1070 | Communication of hazard | 430b | Lateral coordinates |
| | location and type | | |
| 1080 | Responsible parties alerted | 500 | Surveillance camera |
| 1090 | Warning sign deployment | 520 | Ceiling mounted track |
| 1100 | Hazard removal by alerted party | 600 | Surveillance footage |
| 1110 | System notified that hazard is | 610a | X-coordinate |
| | removed | | |
| 1120 | Warning sign removed | 610b | Y-coordinate |
| 200 | Sign projection system | 710 | Drone |
| 210 | Projector | 720 | Projected sign |
| 220a | Servo motor (for horizonal | 810 | Deployed retractable |
| | movement) | | sign |
| 220b | Servo motor (for vertical | 820 | Retracted retractable |
| | movement) | | sign |
| 230 | Horizontal movement | | |

What is claimed is:

1. A method of detecting and responding to hazards, comprising the steps:
obtaining real-time video feed from surveillance infrastructure consisting, at least in part, of optical imaging devices;
processing said video feed through an algorithm configured to detect, classify, and identify location of said hazard;
upon detection of hazard, communicating presence of, type of, and location of said hazard to a response system;
deploying a warning sign at the physical location of said hazard proximal said hazard;
generating an auditory and visual alert to inform cleaning personnel of said hazard; and
upon remediation of said hazard, deactivating said alert and said warning sign.

2. A system for detecting and responding to hazards, comprising:
a computer-readable medium containing instructions to receive live video feed and to execute an algorithm configured to,
detect the presence of hazards on the floor of the surveilled premises,
classify the type of said hazard, and
identify the location of the hazard on the floor of the surveilled premises;
a response system to,
generate visual and auditory signals to alert cleaning personnel and patrons of the presence of a hazard, and
deploy a sign to mark the location of said hazard proximal said hazard; and
a computing device to interact with said response system.

3. The system of claim 2, further comprising:
a reference grid superimposed on a virtual representation of the floor plan of the surveilled premises, and
the surveillance infrastructure and response system calibrated to said grid to enable accurate location mapping of hazards.

4. The system of claim 2, further comprising:
a reference grid superimposed on the viewing frame of the surveillance footage, and
the surveillance infrastructure and response system calibrated to said grid to enable accurate location mapping of hazardous conditions.

5. The method of claim 1, wherein the algorithm is trained by:
obtaining a dataset comprising a plurality of annotated images of hazardous conditions that may cause one to fall or sustain injury;
generating a machine learning model comprising one or more layers of artificial neural networks;
training the machine learning model on the annotated images using a supervised learning technique; and
evaluating the performance of the machine learning model using validation datasets.

6. The method of claim 5, wherein the annotated images comprise live surveillance footage of hazardous conditions.

7. The method of claim 5, wherein the machine learning model comprises a convolutional neural network.

8. The method of claim 5, wherein the supervised learning technique comprises backpropagation.

9. The method of claim 5, further comprising fine-tuning the machine learning model using transfer learning.

10. The method of claim 5, further comprising adjusting the hyperparameters of the machine learning model to optimize its performance.

11. The method of claim 5, further comprising augmenting the dataset with synthetic images to increase the size and diversity of the training data.

12. The method of claim 3, wherein the hazardous conditions comprise one or more of spills, obstructions, falling object hazards, and trip hazards.

13. The response system of claim 2, wherein a visual alert is generated by ceiling-mounted projection systems.

14. The response system of claim 2, wherein a visual alert is generated by shelf-mounted projection systems.

15. The response system of claim 2, wherein a visual alert is administered by:
retractable signs installed at equal intervals around the surveilled premises, and
upon detection of hazard, activation of the retractable sign in closest proximity to the hazard.

16. The response system of claim 2, wherein a visual alert is administered by a drone navigating to the location of said hazard and projecting a visual alert at said location.

17. The response system of claim 2, wherein a visual alert is administered by a drone navigating to the location of said hazard and delivering a physical sign to said location.

18. The response system of claim 2, wherein said response system is equipped with a data transmission protocol whereby cleaning personnel can be alerted.

19. The response system of claim 2, wherein an auditory alert is transmitted over intercom.

20. The response system of claim 2, wherein an auditory alert is transmitted through a computing device.

21. The response system of claim 2, wherein an auditory and visual alert is administered through a push notification on a mobile device.

22. The response system of claim 2, wherein said response system can be controlled by a computing device.
